(19) United States
(12) Patent Application Publication
(10) Pub. No.: US 2021/0126794 A1
(43) Pub. Date: Apr. 29, 2021

(54) METHODS, APPARATUS AND SYSTEM FOR IDENTIFICATION VERIFICATION

(71) Applicants: Chris FORRESTER, Toronto (CA); Kristofer COWARD, Toronto (CA); Joseph WEINBERG, Toronto (CA); Fredrico NASSIRE, North York (CA); Juan Aja AGUINACO, Toronto (CA); SHYFT NETWORK INC., St. Michael (BB)

(72) Inventors: Chris FORRESTER, Toronto (CA); Kristofer COWARD, Toronto (CA); Joseph WEINBERG, Toronto (CA); Fredrico NASSIRE, North York (CA); Juan Aja AGUINACO, Toronto (CA)

(73) Assignee: SHYFT NETWORK INC., St. Michael (BB)

(21) Appl. No.: 17/052,044

(22) PCT Filed: Apr. 30, 2019
(86) PCT No.: PCT/CA2019/050562

§ 371 Date: Oct. 30, 2020

Related U.S. Application Data
(60) Provisional application No. 62/664,689, filed on Apr. 30, 2018.

(51) Int. Cl. H04L 9/32; G06Q 30/00; G06Q 10/10; G06Q 40/02; G06Q 40/04; G06F 16/27

(52) U.S. Cl. CPC H04L 9/3239; G06Q 30/0185; G06Q 10/10; G06Q 40/02; G06Q 2220/00; G06F 16/27; H04L 9/3249; H04L 9/3252; H04L 2209/38; G06Q 40/04

(57) ABSTRACT

In accordance with embodiments of the present disclosure, systems, methods, and computer readable medium for providing verification services on a blockchain network including user identity verification for financial services wherein service providers may conduct know your customer diligence and infer trustworthiness through repeated positive interaction with known individuals.

### FIELD OF THE INVENTION

The invention relates to the creation, transfer, and storage of digital identification information between service providers. More specifically, the present invention is directed to a distributed, multilayer blockchain based network wherein users can securely obtain, store, inquire about, and work with regulatory compliance-satisfying data.

### BACKGROUND OF THE INVENTION

Recent developments in financial technology have required industry participants such as financial institutions and regulatory bodies to quickly adapt or risk disruption and/or catastrophic failure. One such example may be compliance obligations for financial institutions which are increasing in number, complexity, and rigor. Costs of satisfying these obligations continue to rise exponentially. Anything less than strict compliance can result in significant legal penalties and/or reputational damage.

For banks and large institutions, compliance represents a substantial drain on resources, and for smaller institutions can stifle even basic operation.

Inefficient compliance onboarding processes cost the average global bank $61 USD million a year. Costs in the UK can range from $13 to $130 USD per individual compliance check, and the average UK bank currently wastes $6.5 million USD each year due to manual and inefficient compliance onboarding processes. This annual waste may be expected to rise to $13 million over the next three years.

Financial firms with $10 billion in revenue or greater spent on average of $150 million on know your customer (“KYC”) compliance in 2017, up from $142 million in 2016.

Financial institutions have coped by implementing various solutions. The current approach may be to simply raise headcount and deploy larger and larger amounts of capital to meet new external and international mandates. This approach may be crude, provably unscalable, and, over time, has shown to have diminishing returns.

Half of global financial institutions have added employees to keep up with KYC compliance over the past year, and compliance professionals deployed to handle KYC increased by over 3.5 times, from an average 68 employees in 2016 to 307 in 2017. In 2013, JPMorgan spent an additional $1 billion on financial controls, and added 4,000 employees to their compliance department. Of these compliance costs 75-85% are represented by anti-money laundering (“AML”)-related spending, where analysts spend 75% of their time on data collection, and 15% on data organization and entry.

Despite the significant increase in resources, the time required to perform compliance operations continues to lengthen—on average taking 26 days to on board a client in 2017, up from 24 days in 2016. With the average time needed to screen a high-risk customer being 5.4 hours in 2016.

On top of this, compliance processes can be repeated multiple times by subdivisions of an organization because of what is known as “data siloing”, effectively increasing costs. Data silos are repositories of data which exist specifically for and remain under the exclusive control of particular divisions of an organization. One division's repository is often inaccessible to other divisions and/or incompatible with those other divisions' systems, despite this data being useful to both divisions. These inefficiencies stem from a lack of flexibility and poor interoperability between the organization's manual, technological, and bureaucratic systems.

Furthermore, the costs described above are inclusive of only those for conducting compliance procedures and not the protection of the data procured. Data protection is its own risk and cost center as can be seen from the widely publicized data incidents and breaches which are increasing in frequency and size. Organizations, especially large, slow-moving, bureaucratic enterprises, are trailing behind in the IT security-cybercrime arms race.

Blockchain-based distributed ledger technologies have the potential to streamline, cut costs, and reduce the risks inherent to traditional compliance systems, including those related to data breaches. However, most, if not all current blockchains operate and are designed on the principles of anonymity, collection of any user data, let alone collection of data that satisfies regulators, is antithetical to the fundamental purpose of these blockchains. Furthermore, no blockchain is currently adapted to solve the unique technical challenges related to handling compliance data despite the need for a devices, systems and/or method that automate the compliance process.

Pseudonymous blockchains, like Bitcoin and Ethereum, display a limited amount of information regarding the origin, amount, and destination of data. These solutions, while practical and attractive for those wishing to move value outside the financial system, are difficult to integrate with services that cannot avoid KYC/AML regulation, e.g. most, if not all, traditional financial services institutions. Generally, this is a non-starter for traditional financial service providers and so both the institution and its customers are excluded.

The devices, systems and/or methods of the prior art have not been adapted to solve the one or more of the above-identified problem thus negatively affecting the ability to securely obtain, store, inquire about, and work with regulatory compliance-satisfying data.

It is an object of the present invention to obviate or mitigate one or more of the aforementioned disadvantages and/or shortcoming associated with the prior art, to provide one of the aforementioned needs or advantages, and/or to achieve one or more of the aforementioned objects of the invention.

### SUMMARY OF THE INVENTION

The present invention facilitates the accessibility and organization of compliance-satisfying data by leveraging the trustlessness of distributed ledgers and the programmability of smart contracting. In the context of KYC/AML regulations, this coupling has the potential to drastically reduce the resources necessary for compliance. Functioning as a distributed network, embodiments of the present invention have no single point of failure susceptible to centralization risk inherent to traditional compliance systems, i.e., it is difficult to hack, allowing compliance to become cheaper, faster, and more secure.

Embodiments of the present invention may be adapted to allow an ecosystem of applications to utilize the invention, and is intended to serve both traditional and blockchain-based industries. Startups and established businesses alike may participate by providing the compliance data layer, creating and developing applications, or consuming network services. In this fashion, the preferred embodiments of the present invention can allow organizations seeking to upgrade their costly and risky compliance systems to act as nodes on the network, as well as allowing application providers to leverage the compliance data provided by such organizations.

In an embodiment of the present invention, there is provided methods and systems for identity verification of a first user by a second user implemented on a distributed ledger; the method or system comprising: (a) the first user submitting first user verification information to a verifier; (b) the verifier verifying the identity of the first user on the basis of the first user verification information and the verifier provides a public verification of the first user stored to the distributed ledger; and (c) the second user receiving the public verification of the verifier stored on the distributed ledger upon transacting with the first user.

In another embodiment of the present invention, the method or system noted above further provides that wherein step (b) further comprises storing the first user verification information in a secure private environment.

In another embodiment of the present invention, the method or system noted above further provides that wherein the first user verification information comprises digital copies of identifying documents of the first user, cryptographic hashes of those digital copies, and a metadata stored in a bitmap or by other means.

In another embodiment of the present invention, the method or system noted above further provides that wherein the identity verification transaction is stored on the distributed ledger.

In yet another embodiment of the present invention, the method or system noted above further provides that wherein the distributed ledger is a blockchain.

In yet another embodiment of the present invention, the method or system noted above further provides that wherein the blockchain is compatible with the Ethereum Virtual Machine.

In yet another embodiment of the present invention, the method or system noted above further provides that wherein the identity verification transactions are confirmed by a verification node.

In yet another embodiment of the present invention, the method or system noted above further provides that wherein the verification nodes are in communication with a bridge node monitoring activity on the distributed ledger.

In yet another embodiment of the present invention, the method or system noted above further provides that wherein the bridge node utilizes a smart contract to preserve the contents of the distributed ledger.

In yet another embodiment of the present invention, the method or system noted above further provides that wherein the bridge node utilizes a smart contract to preserve the contents of the distributed ledger across a plurality of blockchains.

In yet another embodiment of the present invention, the method or system noted above further provides that wherein step (c) further comprises the transmission of the first user's identity verification information over a communication channel to the second user.

In yet another embodiment of the present invention, the method or system noted above further provides that wherein the transmission of identity verification information utilizes a de Bruijn sequence to find the requested identity verification information.

In yet another embodiment of the present invention, the method or system noted above further provides that wherein the verifier is a financial institution.

In yet another embodiment of the present invention, the method or system noted above further provides that wherein the financial institution is a bank.

In yet another embodiment of the present invention, the method or system noted above further provides that wherein the financial institution is an exchange.

In yet another embodiment of the present invention, the method or system noted above further provides that wherein the verifier monitors the identity verification transaction, provides notification and restricts the ability for the first or second user to engage in the identity verification transaction.

Other advantages, features and characteristics of the present invention, as well as methods of operation and functions of the related elements of the system, method, device and computer readable medium, and the combination of steps, parts and economies of manufacture, will become more apparent upon consideration of the following detailed description and the appended claims with reference to the accompanying drawings, the latter of which are briefly described herein below.

### BRIEF DESCRIPTION OF THE DRAWINGS

The novel features which are believed to be characteristic of the system and device according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic of an embodiment of the present invention;

FIG. 2 is a schematic of a further embodiment of the present invention;

FIG. 3 is a schematic of a further embodiment of the present invention;

FIG. 4 is a schematic of a further embodiment of the present invention;

FIG. 5 is a schematic of a further embodiment of the present invention;

FIG. 6 is a schematic of a further embodiment of the present invention;

FIG. 7 is a schematic of a further embodiment of the present invention; and

FIG. 8 is a schematic of a further embodiment of the present invention.

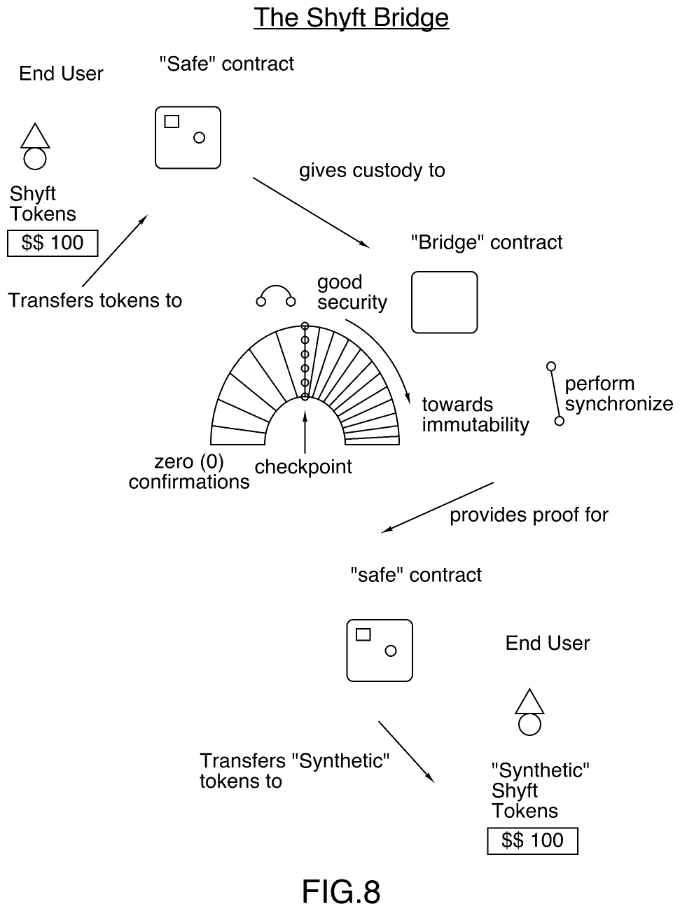

### DETAILED DESCRIPTION OF THE PREFERRED EMBODIMENTS

The description that follows, and the embodiments described therein, may be provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain embodiments and features of the invention.

The present disclosure may be described herein with reference to system architecture, block diagrams and flowchart illustrations of methods, and computer program products according to various aspects of the present disclosure. It may be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The present disclosure may be now described in terms of an exemplary system in which the present disclosure, in various embodiments, would be implemented. This may be for convenience only and may be not intended to limit the application of the present disclosure. It may be apparent to one skilled in the relevant art(s) how to implement the present disclosure in alternative embodiments.

In this disclosure, a number of terms and abbreviations may be used. The following definitions and descriptions of such terms and abbreviations are provided in greater detail.

As used herein, a person skilled in the relevant art may generally understand the term “comprising” to generally mean the presence of the stated features, integers, steps, or components as referred to in the claims, but that it does not preclude the presence or addition of one or more other features, integers, steps, components or groups thereof.

It should also be appreciated that the present invention can be implemented in numerous ways, including as a process, method, an apparatus, a system, a device, a method, or a computer readable medium such as a computer readable storage medium or a computer network wherein program instructions are sent over a network (e.g. optical or electronic communication links). In this specification, these implementations, or any other form that the invention may take, may be referred to as processes. In general, the order of the steps of the disclosed processes may be altered within the scope of the invention.

Embodiments of the present invention may implement artificial intelligence (AI) or machine learning (ML) algorithms. AI and ML algorithms are general classes of algorithms used by a computer to recognize patterns, and may include on or more of the following individual algorithms: nearest neighbor, naive Bayes, decision trees, linear regression, principle component analysis (“PCA”), support vector machines (“SVM”), evolutionary algorithms, and neural networks. These algorithms may “learn” or associate patterns with certain responses in several fashions, including: supervised learning, unsupervised learning, semi-supervised learning, and reinforcement learning.

Embodiments of the present invention may implement cryptographic signatures. As used in the present description, persons skilled in the art would understand reference to a user's signature as relating to the signing of an electronic message with a cryptographic function. This may include the use of public-key cryptographic algorithms, including but not limited to, Rivest-Shamir-Adleman (“RSA”), Digital Signature Algorithm (“DSS”), Elliptic Curve Digital Signature Algorithm (“ECDSA”), or Edwards-curve Digital Signature Algorithm (“EdDSA”), to confirm that a message is from an individual in possession of a private key associated with the disclosed public key, preferably allowing the receiving party to ensure the origin and authenticity of the sender.

Embodiments of the present invention may implement a “de Bruijn sequence” which is a cyclic sequence in which every possible string of a certain length of a parent string occurs exactly once as a substring. For example, the de Bruijn sequence of substring length 2 for the parent string {0011} is: {0,0},{0,1},{1,1},{1,0}.

The present invention generally relates to methods and apparatus for utilizing a distributed ledger, such as, but not limited to, the Ethereum blockchain, the QTUM blockchain, the NEO blockchain, and Cardano, to monitor and execute a process between parties who may be unknown to each other, may not trust each other, etc. Data compliance and retention can be problematic if the parties involved have a lack of trust in each other. For example, if there are several parties in collaboration, it can be hard to make a decision on which organization should control the process that ties them together. Parties typically would need to trust a central authority or simply take a risk on one of the parties themselves. In a preferred aspect of the present invention, a blockchain may be utilized to replace a central authority and facilitate the data retention and/or compliance process. The computational infrastructure of blockchain can be used to either monitor or coordinate such processes.

As used in the present description, persons skilled in the art would understand, the term “hash” to be the output of a hash function, which is a function that can be used to map data of arbitrary size to data of fixed size, such as, but not limited to the MD5, SHA-1, or SHA-2 functions. A person skilled in the art would also understand a “merkle tree” to be a hash tree which allows efficient and secure verification of the contents of large data structures, preferably by computing the hash of the combined hashes of records lower in the tree.

As used in the present description, persons skilled in the art would understand, the term “smart contract” to mean a self-executing contract with the terms of the agreement between the parties written into code that is run on a distributed ledger. The term “smart contract” may refer to both the code that is used to execute a smart contract and the actual executing or executed smart contract. The current disclosure uses the term “blockchain” to refer to actual blockchain itself (that is, the public shared ledger with blocks added sequentially). The current disclosure also uses the term blockchain in relation to a blockchain network. Where the term blockchain network is used (for example the Ethereum blockchain network), this is intended to refer to the computers running the blockchain code that are able to communicate with each other via a communications network such as the Internet. Computers in the blockchain network are referred to as nodes, and a “full node” is a computer in the blockchain network that contains a copy of the entire blockchain. The present invention is described in terms of the Ethereum blockchain; however, the process, systems, and subsystems described herein would be equally applicable to other distributed ledgers and blockchains (e.g. Stratis, LISK, and EOS).

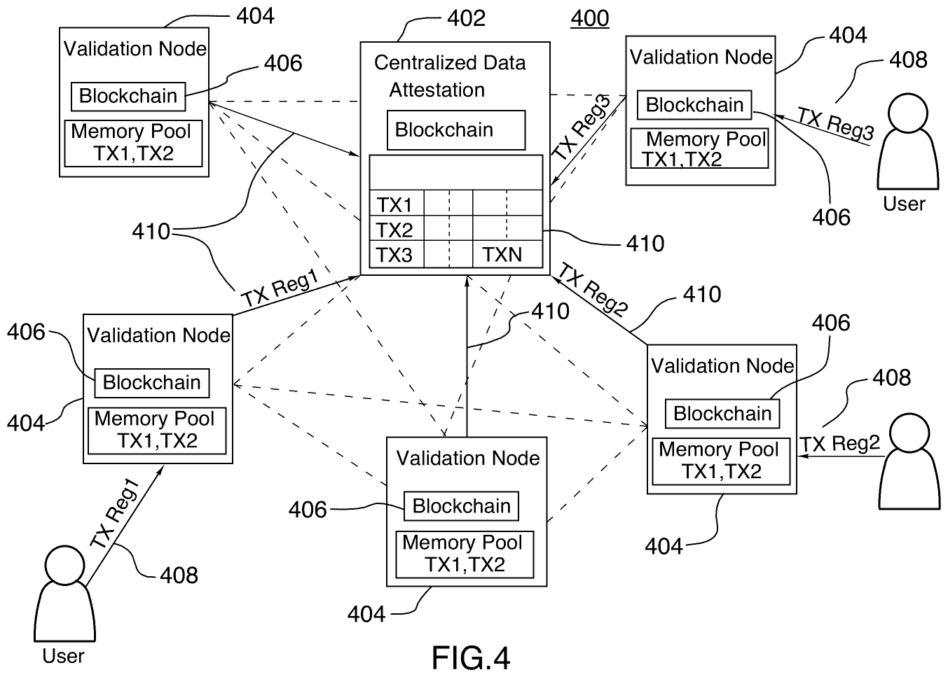

As depicted in FIG. 4 the present invention is preferably implemented as a combination of a centralized data attestation subsystem (see, for example, 402 in FIG. 4, hereafter referred to as a “Shyft Bridge”); an expansive network of validation nodes (see for example 404 in FIG. 4), which serve to validate transactions on the network, preferably ensuring there is no inconsistency between the data on the public ledger and the data used in the proposed transaction, while also preferably providing a connection to the outside world (hereafter referred to as a “Shyft Ring”); and a smart contract compatible blockchain architecture, running on a Shyft Bridge and a Shyft Ring simultaneously (see 406 in FIG. 4, hereinafter referred to as a “Shyft blockchain”). All of the aforementioned elements may be referred to as a “Shift Network” (see 400 in FIG. 4). In a preferred embodiment, a Shyft blockchain is preferably based on the Ethereum blockchain's codebase, running on the Ethereum Virtual Machine (“EVM”) preferably with one or more of the following additional rules:
(a) All Shyft Ring nodes must forward end-user requests 408 to Shyft Bridge 410.
(b) All Shyft Ring nodes must validate the end-user transaction requests in a Shyft Ring memory pool, comprising of end-users requests 408 which have not been included in the blockchain, up to the limit, of a Shyft Bridge's defined capacity 410.
(c) Blocks that are generated by nodes on the blockchain which are close to being the “correct” next block in the blockchain, which are not included in the main chain because they were resolved after the first correct block are rewarded on a granular depreciating basis dependent on the active computing power of a Shyft Ring node, such that in a preferred embodiment this reward decreases with the number of nodes in a Shyft Ring.
(d) All Shyft Ring nodes must process any end-user transaction, and immediately signal and provide proof to the network of a malicious actor activity preferably including but not limited to attempts to double spend, where an end-user has requested a transaction occur using an asset which has already been spent in a previous transaction, or obviously invalid timestamps.

In a preferred embodiment, a Shyft Network of the present invention may also be adapted to utilize other Peer-to-Peer (P2P) proof-of-work (PoW) blockchains, in addition to distributed settlement systems with stronger security guarantees, for example employing a Strong Federation design [Strong Federations: An Interoperable Blockchain Solution to Centralized Third-Party Risks: https://arxiv.org/abs/1612.05491].

A Shyft Network preferably may act as a KYC-based, safety conscious, open standard operating system, which allows data providers to act as data “oracles”, enabling high-level connectivity of applications and other services, and may enable developers to have local machines running the majority of their private infrastructure, while applications utilizing a Shyft Network can be architected within the “cloud”. As local machines are also able to be validation nodes on a Shyft Ring, all of the information on the entire Shyft Network can be attested to in a distributed, transparent manner. Preferably developers can post attestations, state configurations, and registries of assets and indexes, powering the next generation of trustless applications, preferably allowing users to interact with each other without meeting or confirming identifying information outside of a Shyft Network.

A Shyft blockchain preferably allows third parties and data attestors, who are preferably known parties and may include, but are not limited to, financial institutions such as banks, exchanges, or any organization or business for which compliance and KYC/AML processes are an integral part of customer onboarding and maintenance, which are capable of certifying the accuracy of certain data elements to which they attest (“Trust Anchors”) to onboard new users, by preferably attesting to some base amount of identifying information, preferably in the form of (1) the attestation itself to a specific “identified address”, (2) the time of validity of said attestation, and (3) a smart contract (which may or may not be a provided generic standard supplied by Shyft or another ecosystem infrastructure partner) address that can initiate the retrieval process. Preferably, in order to provide additional security to the entire blockchain, a machine learning system (the “Shyft Conservator”) is used to investigate and confirm the validity of the information collected through KYC forms.

A Shyft Conservator preferably operates as a Trust Anchor that can provide an agreed upon service to account holders that wish to have notifications and/or restrictions if their account behaviours are not consistent with their usual purchase patterns, and monitors other non-financial data, preferably including, but not limited to, transaction signatures (for example, data transference and activations of smart contracts) that are outside of the scope of normal activities. This is a basic anti-fraud and identity monitoring service, connected to a Shyft blockchain.

Preferably, certain transactions on a Shyft Network require compliance-satisfying information from users. Users provide this compliance-satisfying information including, but not limited to, the user's personal information, jurisdictions that user operates in, and other data relating to an individual which may serve to satisfy compliance laws and regulations) to a Trust Anchor, who associates that user's signature with that information (this association can be included within the transaction ledger, or can be posted to a secondary ledger that operates in parallel to the transaction ledger). Then, via encrypted communication, this association can be used as a means for third-party application providers to retrieve compliance data for regulators and compliance departments as needed, i.e., the identity of the user is not disclosed but his reputation can be confirmed via attestation.

In a preferred embodiment, a blockchain of the present invention may facilitate the collection of users' data outside of the blockchain using traditional databases and collection strategies with the ability to provide attestation points for third-parties' utilization, and preferably is an extension of the Ethereum codebase that allows at a protocol level the capability to read and write the attestation data that KYC/KYB data providers require to function. In a preferred embodiment, for example, if a financial institution wants to confirm that a user has completed KYC requirements in order to participate in a high-value financial transaction, confirmation can be found on the blockchain of the present invention (e.g. in a preferred embodiment, a Shyft blockchain), yet this confirmation would not disclose the user's personal information, mitigating data leak risk. In a preferred embodiment, the use of the Ethereum codebase achieves a much greater standardization in the formats that are required in the attestation process, along with reducing the transaction execution cost with regards to lookups to the KYC/KYB database elements.

A preferred embodiment of the present invention enables financial institutions and other players to create products (e.g., asset-backed or collateralized loans and debt instruments, ETF's, hedge-funds, derivatives, etc.) and capture a filtered, target market. Preferably applications on a Shyft blockchain can also extend beyond financial markets and may be limited only to the topology of trust required for execution of a contract.

When transactions are being verified for inclusion in the ledger, adequate available KYC information for both the sender and recipient may be a criterion for a valid transaction in much the same way that the outputs of a transaction not exceeding the value of the inputs is a common criterion for valid transactions. Raw data types may have converters that are specified, with representations of what raw data has been converted. When raw data is posted unconverted to a blockchain it may be preferably specified in a plain language data field visible to the public.

Given the diverse nature of compliance processes and data points, a KYC Matrix may be used to ease participation of Trust Anchors, decentralized/distributed application (“Dapp”) developers, and end users via smart contracts in a Shyft blockchain ecosystem. This may also facilitate future-proofing through community involvement.

A Shyft blockchain preferably includes additional virtual machine instructions for smart contracts to check available KYC data for an address. With these additional instructions, token transfers can also be controlled to require suitable KYC. Preferably most tokens running on a Shyft blockchain may preferably adopt a standard extending the Ethereum ERC20 to include function calls testing the validity of transfers and preauthorization for transfers.

All smart contracts running on a Shyft blockchain may preferably be signed by their creators. In order to prevent cross-contamination of smart contract event pools and to reduce the risk of harmful contracts, any smart contract design that attempts to store large amounts of a Shyft token or another token may be flagged and the application code responsible may go under code review. The amount for which code may be flagged for review preferably may be based on the Integrated Exchange Valuation (“IEV”) score of the tokens with any Trust Anchors serving the price/pair ratio of the tokens. The exchanged value of trades associated with a contract may trigger controls around how that contract may be treated, so that large amounts of value don't get locked or otherwise lost.

For Shyft Network transfers, the transfer value may be preferably calculated as the exchange rate of the asset being transferred multiplied by the amount of the asset. Trust Anchors then compare this transfer value to their individual or collective threshold limits to determine what compliance action may be necessary, if any.

In a preferred embodiment, Trust Anchors can agree on and attest to a specific exchange rate and rate variance within a set time period—the IEV. When transactions are completed by parties on a Shyft blockchain, if there are any Trust Anchors associated with the user's account that define compliance protocols for transaction reporting, the IEV of the asset can be checked to determine reportability of the transaction, and complete additional compliance procedures as needed based on the involved Trust Anchor's attested smart contract suites.

Use of a Shyft blockchain may preferably allow the payment of a Shyft token, which may be a single unit of computational execution similar to “gas” in the EVM language. A purpose of a Shyft Token may be to set a predefined price-per-operation for usage of a Shyft blockchain and the smart contracts therein. This sets upper limits on the execution capability of a Shyft blockchain per block generated, which creates an opportunity to have each validator node apply an algorithm to charge a specific price-per-operation. This preferably creates a situation where a Shyft Network participants could potentially collect this Shyft token and pay on a Shyft blockchain for other services.

In a preferred embodiment of the present invention, a Shyft Ring may be a set of preferably public facing validators preferably compatible with the EVM runtime, this may function similar to a traditional PoW blockchain where participants are necessarily validators for the entire state of the network, completing PoW hashes to propagate blocks and establish security, and are rewarded based on the workload distribution. These validators preferably: confirm the operations within each block of a Shyft blockchain, organize the deployment of PoW and validation efforts, maintain sparse connectivity to a Shyft Bridge preferably to register as a validator, audit a Shyft Bridge's work and notifies other peers if there is a desynchronization state, and forwards all transactions they receives onto a Shyft Bridge. A Shyft Ring may also contain a broadcast component similar to a web API of a block explorer, and may gauge network uptime by randomized polling (once per block) of address data.

Preferably, Shyft Ring validators may participate in consensus-based verification of a Shyft blockchain state, preferably in combination with a distributed network of peers, through the creation of merkle tree “Chords” by compacting the entire, traced tree of transactions per user, and the routing of pre-signed transactions from mobile clients to a Shyft blockchain peers. Chords are preferably created with block hashes as attestation points and function as the primary state verification for incoming mobile requests. Chords preferably allow wallets to resume synchronization with a single hash and allow a cached data repository on a Shyft blockchain capable of servicing cross-blockchain initiatives.

This Shyft Ring preferably serves as a mechanism for a user's wallet software to connect to a distributed network (Shyft Ring validation nodes), with the prevention and detection of censorship. In preferable embodiments, this may be accomplished within a Shyft Network in the following manner:
(a) Pre-signed transactions, which in other systems, may be transactions that require previous logins, previous authorizations, or previous permissions to accomplish, are preferably sent from the user's wallet to a Shyft Ring validator nodes. The node selected may be via random number, system oracle, or factors such as proximity or reputation of the node.
(b) Two or more nodes are preferably selected via this selection process, and each of the nodes' unique identifiers (which are sent from the nodes to the wallet in the establishment of the communication channel) are preferably pre-signed by the user's wallet or alternatively authenticated through other means, and sent to the respective node for inclusion into a Shyft blockchain's memory pool. This may be sent to other nodes in a peer-to-peer manner.
(c) The nodes preferably forward these pre-signed transactions to a Shyft Bridge for accounting purposes, and this pre-signed transaction may be eventually included into a block if it is valid.

In preferable embodiments, the nodes and a user's wallet may have a record of their lines of communication, as the node identifier was sent on the opening of the communication channel between the user's wallet and the node. Preferably this allows a Shyft Network to detect censorship, whether intentionally or not, as a record of communication channels exists. By providing this proof of censorship (which turns into a proof of unavailability if the action was not malicious, for example a node with a high track record of properly forwarding user's pre-signed transactions to a Shyft blockchain's memory pool) to a Shyft Bridge, the user or another node (as they may be able to simply count the number of unique pre-signed messages sent from the user's wallet initially) may preferably be able to claim a reward, introducing an incentivization scheme for availability and faithful execution, or be punished for being censored or unavailable for the communication process.

Preferably, whether by validator nodes bonded through the deposit of assets (Shyft tokens, RMT, or any other asset on a Shyft Network), or through the use of extra rewards (via RMT or other asset on a Shyft Network), a Shyft Network itself becomes a self-policing entity capable of detecting and incentivizing both validator node uptime, and anti-censorship behavior. These incentivization/disincentivization strategies can preferably operate in mutually exclusive, additive, multiplicative, compounded, or any other time-based distribution ways.

In a preferred embodiment, users may maintain a high degree of flexibility by maintaining mobile-based blockchain “thin-clients” (requiring connectivity to a “block explorer” by primary user-facing wallet systems, such as MyEtherWallet.com), while also receiving a high degree of both local and global accessibility to services without having to manually synchronize either full blocks (in the case of a blockchain-based “full client”) or block headers (in the case of a blockchain-based “light client”). Persons skilled in the art may appreciate that the additional requirements to connect and sign a Shyft Ring nodes' own signed messages allows for a system that may be self-policing and fully transparent to all participants, incentivizing good behavior on the network even in areas which might historically block traffic based on profiling rather that true understandings of customers/customer intentions. Persons skilled in the art may also appreciate that as a Shyft blockchain has and may be designed for the development of certain KYC/AML features, as such the described mechanism for a user's wallet software to connect to a distributed network may be required in order to prevent against personally-targeted censorship schemes by Shyft Ring nodes that happen to have misaligned incentives with the network as a whole.

In a preferred embodiment, a “Shyft Bridge” may be a software solution functioning as a Software as a Service (“SaaS”) for Shyft Ring nodes. It may be preferably compatible with the EVM runtime with special permissions to enable the transition of users' assets to other public or private blockchains (or external SaaS, centralized databases, or other data storage mechanisms whether fully or partially operating on the online network of the internet). A Shyft Bridge may be preferably a centralized Shyft Blockchain based attestation engine which functions in tandem with a Shyft Ring to ensure uptime, data availability, and data synchronization. A Shyft Bridge may be preferably shared as necessary on secure servers, running a Shyft blockchain and connecting to pegged sidechain networks via Safe attestations (generically, this could be described as “Merkle Tree Proofs” with pegging being set by smart contracts running on a Shyft and other EVM compatible blockchains, as well as other blockchains that may benefit from such methodologies). The primary operation of a Shyft Bridge may be preferably to be a connection-of-last-resort for a Shyft Network, in the case of a Shyft Ring consensus failure. It may also be a basis for trusted consolidation, accessing a specific randomized merkle hash that may stochastically indicate when there may be a desynchronization of a Shyft Bridge and Shyft Ring across all mobile use cases, where preferably any mobile end-user can be a reliably efficient method of broadcasting these desynchronization states across a Shyft Ring's mobile node connection.

In an embodiment of the present invention, the users' assets are preferably partially (with the user's consent) time-locked. Such that, in a preferred embodiment, only a small fraction of the available assets are easily accessible, and larger transfers are explicitly marked and confirmed by the end users' wallets (with the end users' permissions, this system could be partially or fully automated as well including solutions that may include human beings, AI/ML entities, or both). This subsystem of asset time-locking and safety mechanisms may be referred to as “Shyft Safe”. A Shyft Bridge preferably connects a Shyft Safe and a Shyft Ring. In an embodiment of the present invention, at the end of every block, a Shyft Bridge may gauge a Shyft Ring's block hash and may commit the state to Shyft Bridge smart contracts running on other blockchains within the scope of Shyft's operations, and, preferably if no invalid transactions are detected (hence both hashes are equal), preferably backing up the data on a Shyft Ring to one or many Shyft Bridge compatible blockchains. A Shyft Bridge preferably backs up a Shyft Ring data by means of a Merkle Tree proof and smart contract infrastructure, as previously outlined. Persons skilled in the art may appreciate that being able to serve from the central Shyft Bridge, preferably by connection between Shyft Bridge and a Shyft blockchain means that the average transaction time can be reduced significantly and the reward for a Shyft Ring validation process can be appropriately adjusted.

A Shyft Safe preferably allows, via this time-locked mechanism, an absolute immutable guarantee that creates the structure required to “transit” the user's assets across blockchains.

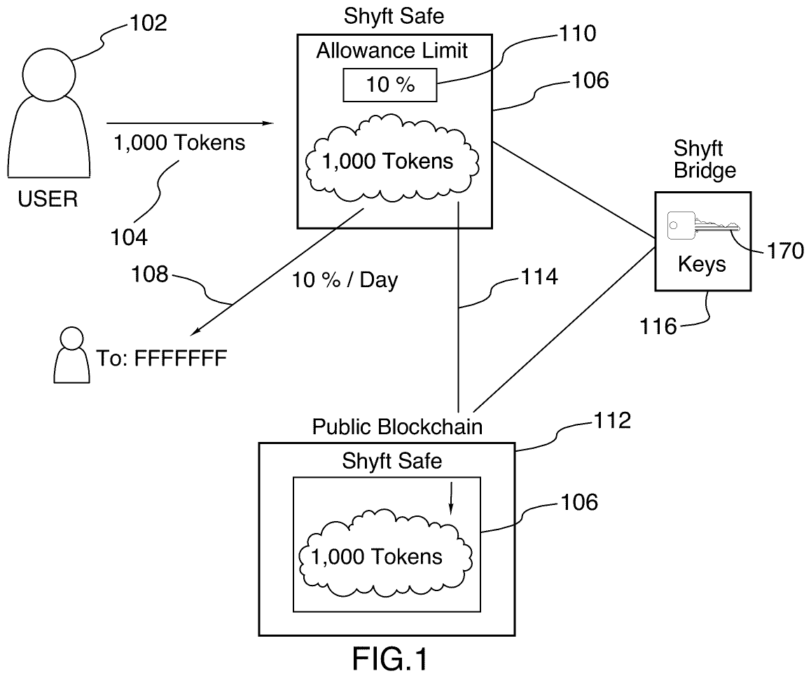

This may be preferably accomplished in the manner shown in FIG. 1:
(a) A user 102 transfers a number of cryptographic assets, which may include, but are not limited to, Shyft fuel tokens 104 (1000 tokens in this example) to a Shyft Safe Contract 106, a smart contract interface which allows for the implementation of a Shyft Safe to be utilized within it. A Shyft Safe smart contract preferably implements an escrow like mechanism allowing a user to transfer assets to it and for the smart contract to release only certain amounts of the asset on the fulfillment of certain conditions.
(b) The user 102, preferably by default, may be able to transfer up to 10% of the tokens in a Shyft Safe contract per day (as determined by 12:00 am AST to 11:59 pm AST) to other accounts and/or native Shyft fuel addresses 108. This default “allowance” limit may be enforced by the smart contract interface 110 (in other systems this allowance may follow other patterns such as “AI” enhanced user spending/transferring pattern recognition, or a human being acting in a similar fashion as an intermediary to allowances, such as a parent to a child) and may be able to be set by the user 102. When the user changes the allowance limitation, this change may preferably take effect at a certain time, or the next block thereof (in other systems this time may be absolute, but based on block timings on a Shyft Network this may be impossible to perform on an exact basis as a block may be completed at, for example 11:58 PM AST and then the next at 12:01 AM AST). This allowance limitation may preferably be changed by the user to have a set amount of tokens able to be transferred instead of a percentage limit, or it may be a percentage limit with a minimum amount (in the case of being able to transfer enough Shyft fuel daily to meet transaction fee requirements on a Shyft blockchain). This process and the enforcement thereof shall be referred to as a “Safed”.
(c) Preferably, while the tokens are Safed, there may be the capability to send these tokens to another public blockchain 112 running a Shyft Safe smart contract 106. This process may be called “transiting” 114.
(d) In this process, a Shyft Bridge 116 preferably has multisignature rights, preferably requiring both the user's and the Bridge's signature to initiate a transaction to “transit” any assets held within Shyft Safe. This limitation creates a situation where the only action that the Bridge can take may be on a user's behalf. This may be triggered by a pre-signed transaction from the user (completing the multisignature access), and preferably may be manually performed if a Shyft Network has a catastrophic failure, as this leads to a condition where it may be known the failure has occurred, and the other blockchains may prove this condition. In this case, by default, the “transit” to the public blockchain 112 may be preferably performed to the Ethereum blockchain as it has all of the necessary smart contract infrastructure (A Shyft Safe contract exists on the Ethereum blockchain, as does a Shyft KYC Contract. These smart contracts may be the same smart contract by means of inheritance, or they may be discrete). This default “transit” location may be changed by the user by means of a pre-signed transaction which only carries data.
(e) When an asset has been “transited” to another blockchain, the asset may preferably become a synthetic form of the base asset. For example, if Shyft fuel tokens (in this case 1000) are sent to a Shyft Safe smart contract on a Shyft blockchain, they may also be transferred out of a Shyft Safe smart contract and returned to the user in the form of Shyft fuel. When “transited” to the Ethereum blockchain however, this Shyft fuel cannot be used to pay for transaction fees on the Ethereum blockchain, and thus may be a synthetic form of Shyft fuel tokens. This synthetic form may be equally lesser or greater in utility value on the Ethereum blockchain, as it may be able to be used for decentralized exchanges, bonding purposes (deposits), lending circles, or other use-cases. When this synthetic Shyft fuel may be “transited” back to a Shyft blockchain, it may once again be able to be exchanged for native Shyft fuel.

Preferably, an oracle like subsystem may be utilized on the Ethereum blockchain (for example, a set of bonded observers of network state that each vote on the validity of certain conditions external to the Ethereum blockchain) and would be able to see that a Shyft blockchain has suffered a catastrophic failure and would thus enable users to use their own multisignature key in association with a value(s) set on the Ethereum blockchain to recover any assets that they had had on a Shyft blockchain by means of a merkle tree proof that may be valid for the last known functional block in a Shyft blockchain. As a Shyft blockchain recovers, a Shyft Bridge would examine the existing Ethereum or other EVM/Shyft Safe compatible blockchains in order to determine the proper Safe status for the assets of the users that “transited” their assets to those blockchains when a Shyft Network was unavailable.

Persons skilled in the art may appreciate that the implementation of a Shyft Bridge allow a Shyft Network to guarantee security (by having oracles on other completely independent blockchains able to see whether a Shyft blockchain may be functional), and to simultaneously have the ability to “fail gracefully” and enable users to maintain the liquidity of the majority of their assets while a Shyft blockchain may be unavailable.

The formation of Trust Channels between Trust Anchors preferably allows information and transactional flow. Direct trans-institutional transfers of compliance data over Trust Channels solves inter-anchor data siloing, affording even greater cost savings for the institutions. Preferably application calls to a Trust Channel can be “automatically” allowed, giving rise to an attestation system that allows users to be automatically authenticated for Shyft-verified smart contract services running bet ween any Trust Anchors assigned to the Trust Channel.

Although the EVM may be technically “turing complete”, the cost to perform certain function quickly becomes extremely expensive depending on the number of operations performed in a single smart contract function call, with an iterative functions being particularly expensive. Some functions are impossible to run on an EVM compatible blockchain as the costs exceed that of a “block gas limit” (the limit to the number of operations that can be ran in a single Ethereum blockchain-like block). As normal methods of storing data inside of databases or other query-compatible structures (including flat file storage or in-memory arrays) utilize iterative functions for iterating across data elements, on the EVM compatible blockchains, this method does not work. This limits total program functionality and creates issues with matching or allocating data elements.

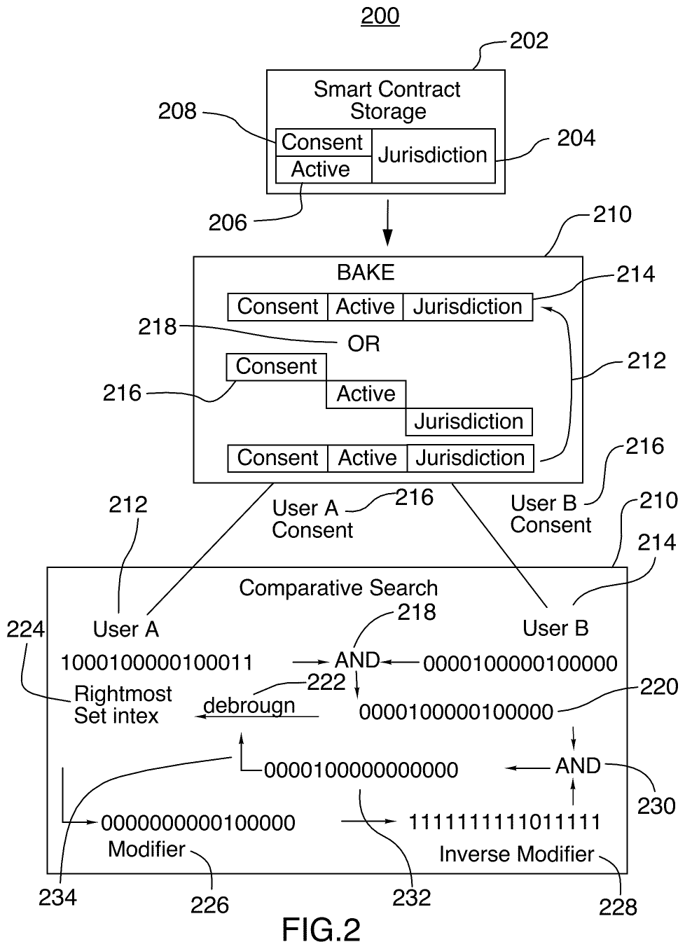

To overcome these and other limitations, the present invention employs “Trust Channels” that the Trust Anchors (data attestors to users' accounts) are associated to. Preferably “Read” operations, including comparison of multiple data elements are computationally inexpensive to conduct. Trust Channels are preferably composed of one or more Trust Anchors, and may have specific requirements to utilize. These Trust Channels are written to as another data element parameter. As depicted in FIG. 2, trust channels preferably accomplish this through the use of a “commit, bake, comparative search” methodology 200 in the following manner:

Commit: A data element with a data search parameter may be written to in smart contract storage 202, e.g. jurisdiction 204. Preferably, users may consent to this information being used in further calculations, and thus “consent” may be written to for this data element 206. Further, a timeline may be set, and depending on whether this timeline may be within the current blockchain time signature, “active” may be written to this data element 208.

Bake: The “baking” process 210 preferably loops across all data elements 212 within a conventional array, mapping, or other iterable data structure. Preferably the loop may be bound by the block's gas limit, and further “baking” passes may be done in future blocks on the EVM-compatible blockchain. This loop's purpose may be to update mappings of the data search parameters in relation to the data element's owner. The existing mapping 214 may be bitwise-OR′d together based on their Trust Channel 216, that may be the sum of their information are overlapped onto the mapping so long as the Trust Channel matches 218 (other implementations might have the bitwise-OR operation with another data element parameter as the combination/matching parameter).

Comparative Search: The comparative search process 210 preferably utilizes the de Bruijn sequence of a bitwise-AND between data elements desired to be compared to avoid iterating over each individual data element.

For example, consider two users, user_a 212 and user_b 214. These users wish to send a transaction to one another. This transaction should only be only be sent if they have both consented to their data being used (hence both users' have the parameter “consent”), the data may be valid (hence “active”), and the jurisdiction may be identical (hence both users have the same “jurisdiction” parameter with an equal value).

Mappings for “consent” are looked up for both users 216, and are bitwise-AND′d together 218. Assuming the mapping may be a 16 bit word (a “uint16” in the Solidity programming language, for example), the following may appear (for 16 data elements that have a known context)
User_a 212: 1000100000100011
User_b 214: 0000100000100000
Result 220: 0000100000100000

The resultant map 220 now contains two “1” bits, in the indexes of (from right to left, starting at index #0) #5 and #11. Instead of iterating through each possible bit to see if there is a “1” at that index (which would be costly by default, and as outlined above simply impossible due to EVM-compatible blockchain block gas limits), a de Bruijn sequence is used to find the rightmost set bit (in this terminology, “set” equates to “is a 1”) 222. The result of this calculation 224 can be used outright, and if the next rightmost set bit is desired, a 16-bit word with the previously calculated set bit 226 may be inversed 228 (transforming all of the 0's to 1 's) and AND′d with the result 232, thus setting that bit to a zero and resulting (as in this example) as:
Result 220: 0000100000100000
(rightmost set bit is index 5)
Modifier 226: 0000000000100000
Inversed modifier 228: 1111111111011111
AND′d new result 232: 0000100000000000

And then the rightmost set bit may be found again 234 by using the de Bruijn rightmost set bit calculation 222, resulting in a new value, of index 11.

Persons skilled in the art may appreciate that even very large word sizes (such as 256 bits, which would classically be extremely expensive if not impossible to loop through on various EVM compatible blockchains) may be used in this way, preferably by splitting up each 256 bit word into 4 smaller 32 bit words, and performing the rightmost bit calculation upon then. In preferred embodiments each 32 bit word that is compared between the users may be “ORd” together, and if the result is not 0, there may be a rightmost bit that can be found, and if the result is zero, the next 32 bit word may be compared.

Persons skilled in the art may appreciate that this methodology as a whole enables the comparison of large amounts of arrays in the Read setting, enabling much cheaper comparisons, and enabling comparisons that are simply not possible in the normal method of for loops on an EVM compatible blockchain. Trust channels, in this way, enable the formation of coalitions. Further extensions of this technique would allow for the establishment of linked coalitions, for example a payment gateway trust channel to a lending pool trust channel, or a jurisdictional requirement trust channel to another jurisdictional requirement trust channel, etc. based on data element parameters.

The data storage/reference/retrieval models for the KYC data stored off-chain

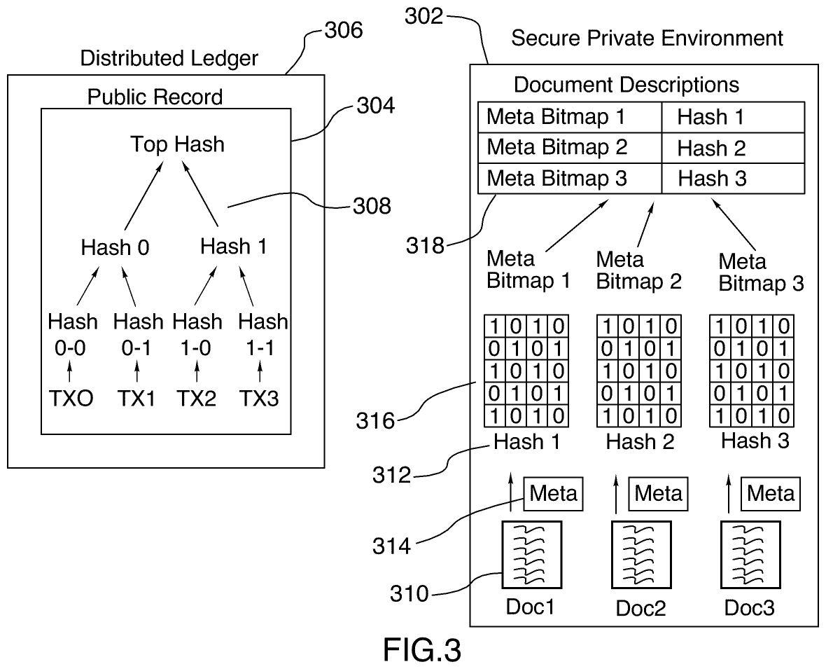

As depicted in FIG. 3 identifying information may be preferably stored and referenced in at least two distinct environments: a (secure) private environment 302, in which identifying information can be warehoused while remaining in compliance with privacy regulations and a public record 304 included on a distributed ledger 306. This public record may be, but does not necessarily have to be, combined with the transaction records; similarly it may be, but does not necessarily have to be, stored within its own reference structure inside the ledger 308 (e.g. on its own Merkle tree, or derivative an analogue thereof). It may also be included on other reference structures in the ledger, which have not already been mentioned.

Preferably the private data may consist of digital copies of identifying documents 310, and cryptographic hashes of those digital copies 312. Additionally, each document may preferably have assigned to it a data structure representing metadata on the document 314 (but not data from the document itself). This metadata may be represented as a bitmap or by other means 316.

In preferred embodiments the aggregation of document metadata and signatures, including, but not limited to, a string of document metadata structures followed (alternating-after each metadata structure and before the next) by the hash of the document being described by the metadata, may constitute a data structure of its own: the Document Description 318.

The Reputation scoring systems enabling “Creditability”

In preferred embodiments a Reputational Merit Token (“RMT”) may be intended to be a reputation storehouse and incentivization mechanism.

Preferably the RMT layer exists above the KYC layer on a Shyft blockchain, and provides reputational credit to those users who are unable to participate on the KYC layer, which may include those without basic access to financial services due to regulatory restrictions. The RMT preferably provides reputation over time to non-KYC′d participants such that they may be awarded with reputational identity and access to the KYC layer, allowing them to utilize financial services otherwise unavailable because of their lack of KYC-ability.

In a preferred embodiment the RMT serves to recognize continued participation in remittance transaction. Preferably remitters (senders) supply KYC data to be allowed to transfer assets to remittees (receivers), who may not have a bank account and therefore have minimal financial or credit history, if any. These “unbanked” individuals are preferably designated Level 0 KYC within Shyft.

Preferably remittance service providers become Trust Anchors on a Shyft blockchain, and are able to allocate RMT tokens to senders and receivers for every remittance transaction. As receivers gain reputation tokens, by receiving funds from KYC participants, they can gain trust and access to the KYC layer.

These tokens are preferably distributed based on the initial KYC of a specific address on a Shyft Blockchain, where the user controls the private key of a Shyft blockchain address. Positive interactions between Trust Anchor partners, who themselves can also KYC and be rewarded RMT for positive interactions with their user-bases (e.g., national bank onboarding).

A sender with good reputation transacting with a receiver that may be insufficiently credible due to lack of KYC data or Level 0 causes the receiver to gain some RMT. Receivers with low level KYC may gain creditability over time through accumulation of the RMT token, becoming more likely to be trusted by institutions in regulated markets, earning access to introductory financial services. This may allow some as-of-yet unbanked consumers to enter the larger financial market.

Persons skilled in the art may appreciate that most KYC processes are often focused on the sender, and having KYC data and financial history on receivers allows financial services companies to offer new services targeted towards this underserved market or add to existing customer bases; new sources of revenue. Persons skilled in the art may also appreciate that when onboarding new customers, institutions may preferably have a baseline compliance history on the receiver to help the business decide how much additional KYC needs to be done should the institution and the receiver seek to escalate their business. Institutions can decide to prioritize further investigation on consumers with a low RMT score (for example, a history of negative interactions between KYC′d users or Trust Anchors) or perform only the required KYC onboarding for those with a high creditability score.

The RMT layer may also allow the monitoring of existing customers who have a positive history overall but frequent negative interactions with a Trust Anchor or KYC′d users. Frequent negative interactions may encourage other Trust Anchors in a Shyft Network to start monitoring the problem customers more closely to prevent fraudulent activity. Trust Anchors can also use this data to give notice to customers that may be at risk of not meeting financial obligations (such as loans, credit lines, etc.).

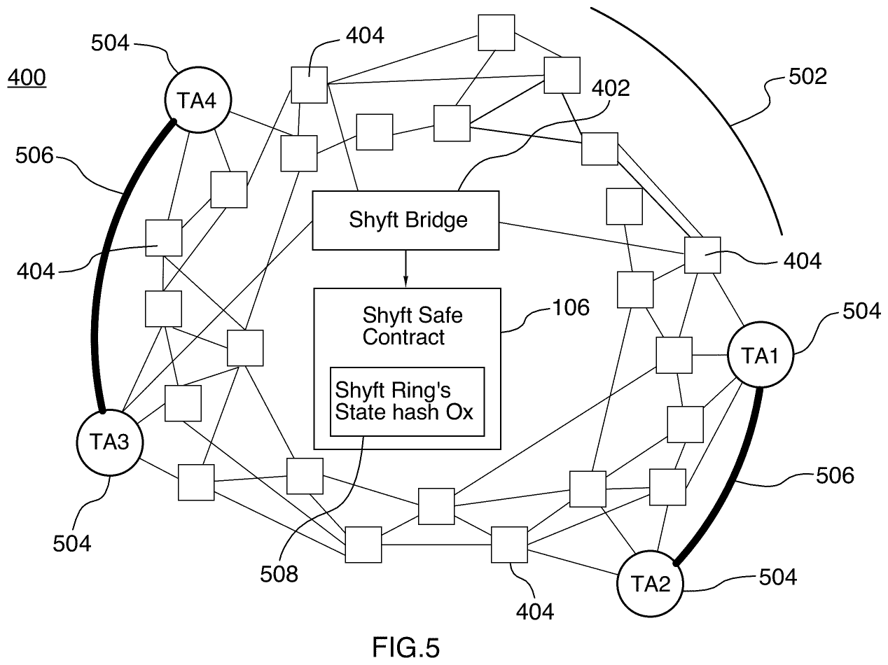

In preferred embodiments, a Shyft Network preferably comprises the various subsystems and components described herein in communication with each other. As depicted in FIG. 5, the network 400 may be preferably comprised of a Shyft Ring 502, validation nodes 404, a Shyft Bridge 402, a Shyft Safe implemented as a Shyft Safe Contract 106, a Shyft Blockchain 406, Trust Anchors 504, Trust Channels 506, and an RMT layer.

Preferably a Shyft Ring 502 may be comprised of a network of validation nodes 404 all in connection with a Shyft Bride 402, which may be preferably a centralized Shyft Blockchain 406 based attestation engine which functions in tandem with a Shyft Ring to ensure uptime, data availability, and data synchronization. A Shyft Bride 402 may be preferably in connection with a Shyft Safe implemented as a Shyft Safe Contract 106. Preferably at the end of every block a Shyft Bridge gauges a Shyft Ring's block hash and commits the state to Shyft Safe if both are equal preferably by depositing the state onto other distributed ledgers 508. Trust Anchors 504 are preferably in connection with validation nodes of a Shyft Ring 502 and with each other through the use of Trust Channels 506. Preferably, the Trust Channels may allow users which already have provide some compliance information to a Trust Anchor to be offered services from other members within the Trust Channel 506 without re-submitting the previously provided compliance information. The RMT layer preferably may be implemented on top of a Shyft network 400 to provide a trust based currency which may be transacted and verified through the function of a Shyft Network 400.

In an embodiment of the invention, validation nodes 404 may be verified using KYC verification requirements, and preferably lead to at least some participants, preferably institutions, to be able to participate in a Shyft Ring themselves, helping further stabilize the network. Preferably these KYC validation nodes would have a heightened inherent ranking such that if consensus fails between a Shyft Bridge and a Shyft Ring, for example in the case where all of the KYC validation nodes voted against a Shyft Bridge's decision, it indicates to the larger network that there may be a potential issue with the communication infrastructure between a Shyft Ring and a Shyft Bridge.

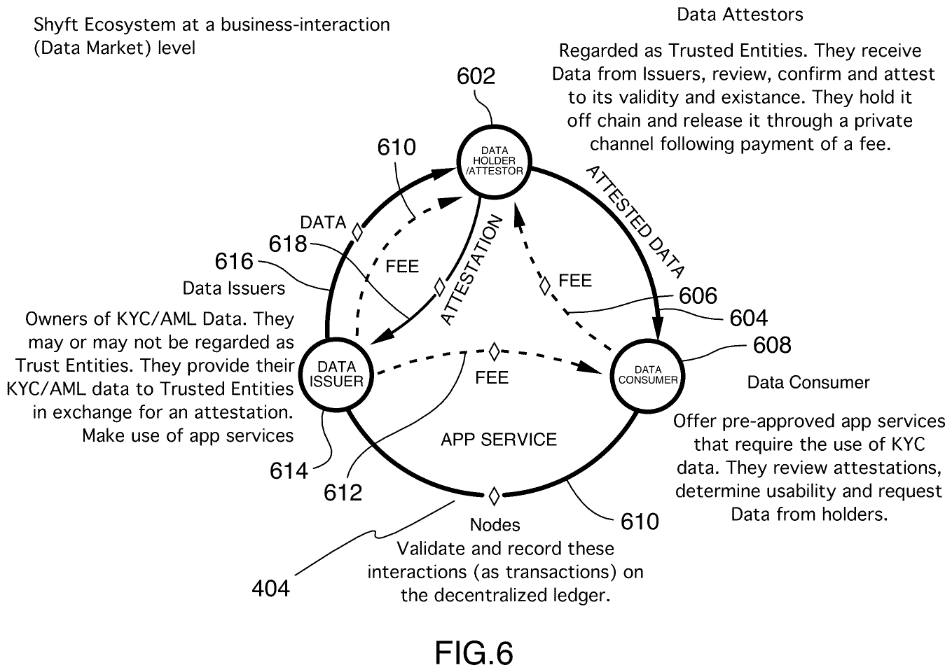

FIG. 6 depicts the functioning of a Shyft Network 400 at a business-interaction/data market level. Preferably data attestors/holders 602, which are preferably trusted entities, which may include Trust Anchors 504 preferably receive data from issuers, review, confirm and attest to its validity and existence. Preferably this information may be held off the blockchain, preferably through the use of a (secure) private environment 302 and may be released through a private channel 604, preferably through a Trust Channel 506 following payment of a fee 606 to data consumers 608. The data consumers preferably offer pre-approved app services that require the use of KYC data. Preferably the data consumers 608 review attestations, determine usability and request data from data attestors/holders 602. Validation nodes 404 preferably record and validate transaction between the data issuer, user, and the data consumer, service provider, preferably using a Shyft blockchain 610 in return for some fee 612, preferably in the form of a Shyft token. Data issuers 614, preferably end-users, are owners of KYC/AML data, preferably relating to the identity of the end-user. Data issuers 614 may or may not be regarded as data attestors/holders 602, and preferably provide their KYC/AML data to data attestors/holders 602 616, in exchange for an attestation by the data attestors/holders 602 618, in return for a fee 620.

A further embodiment of the invention provides mechanisms of cross-blockchain interconnectivity, blockchain asset 100% backed synthetics, and user fund safety in the event of a catastrophic outage of a Shyft Network. A Shyft Bridge may be a software solution functioning as an SaaS for a Shyft Ring nodes. It also runs the ethereum-virtual-machine (“EVM”) compatible runtime of a Shyft network with special permissions to enable the transition of users' assets to other public (or private) blockchains (or external SaaS, centralized databases, or other data storage mechanisms whether fully or partially operating on the online network of the internet).

The users' assets are generally partially (with the user's consent) time-locked. That is, only a small fraction of the available assets are easily accessible, and larger transfers are explicitly marked and confirmed by the end users' wallets (with the end users' permissions, this system could be partially or fully automated as well including solutions that may include human beings, machine learning (colloquially “AI”) entities, or both). This system of asset time-locking and safety mechanisms may be referred to as “Shyft Safe”.

Shyft Safe also allows, via this time-locked mechanism, an absolute immutable guarantee (similar system that rely on fully or in part by centralized databases may have only partial or no similar guarantees of immutability of state) that creates the structure required to “transit” the user's assets across blockchains.

In a preferred embodiment, this may be accomplished in the following manner. A user transfers a number of Shyft fuel tokens (1000 tokens in this example) to a Shyft Safe Contract, a smart contract interface which allows for Shyft Safe to be utilized within it. The user, by default, could be able to transfer up to 10% of the tokens in a Shyft Safe contract per day (as determined by 12:00 am AST to 11:59 pm AST) to other accounts and/or native Shyft fuel addresses. This default “allowance” limit may be enforced by the smart contract interface (in other systems this allowance may follow other patterns such as “AI” enhanced user spending/transferring pattern recognition, or a human being acting in a similar fashion as an intermediary to allowances, such as a parent to a child) and may be able to be set by the user. When the user changes the allowance limitation, this change could take effect at 11:59:59 AST, or the next block thereof (in other systems this time may be absolute, but based on block timings on a Shyft network this may be impossible to perform on an exact basis as a block may be completed at, for example 11:58 PM AST and then the next at 12:01 AM AST). This allowance limitation may be changed by the user to have a set amount of tokens able to be transferred instead of a percentage limit, or it may be a percentage limit with a minimum amount (in the case of being able to transfer enough Shyft fuel daily to meet transaction fee requirements on a Shyft blockchain). This process and the enforcement thereof shall be referred to as a “Safed”.

While the tokens are Safed, there may be the capability to send these tokens to another public blockchain running a Shyft Safe smart contract. This process may be called “transiting”.

In this process, a Shyft Bridge has multisignature rights to “transit” any assets held within Shyft Safe. This limitation creates a situation where the only action that the Bridge can take may be on a user's behalf. This may be triggered by a pre-signed transaction from the user (completing the multisignature access), and may be manually performed if a Shyft network has a catastrophic failure, as this leads to a condition where it may be known the failure has occurred, and the other blockchains may prove this condition. In this case, by default, the “transit” may be performed to the Ethereum blockchain as it has all of the necessary smart contract infrastructure (A Shyft Safe contract exists on the Ethereum blockchain, as does a Shyft KYC Contract. These smart contracts may be the same smart contract by means of inheritance, or they may be discrete). This default “transit” location may be changed by the user by means of a pre-signed transaction which only carries data.

When an asset has been “transited” to another blockchain, the asset may become a synthetic form of the base asset. In a preferred embodiment, if Shyft fuel tokens (in this case 1000) are sent to a Shyft Safe smart contract on a Shyft blockchain, they may also be transferred out of a Shyft Safe smart contract and returned to the user in the form of Shyft fuel. When “transited” to the Ethereum blockchain however, this Shyft fuel cannot be used to pay for transaction fees on the Ethereum blockchain, and thus may be a synthetic form of Shyft fuel tokens. This synthetic form may be equally lesser or greater in utility value on the Ethereum blockchain, as it may be able to be used for decentralized exchanges, bonding purposes, or lending circles (other use-cases may become known as the blockchain/external ecosystem evolves). When this synthetic Shyft fuel may be “transited” back to a Shyft blockchain, it may once again be able to be exchanged for native Shyft fuel.

In a preferred embodiment of the present invention, the system that may be utilized on the Ethereum blockchain for example (a set of bonded observers of network state that each vote on the validity of certain conditions external to the Ethereum blockchain) would be able to see that a Shyft blockchain has suffered a catastrophic failure and would thus enable users to use their own multisignature key in association with a value(s) set on the Ethereum blockchain to recover any assets that they had had on a Shyft blockchain by means of a merkle tree proof (rational and example implementation: https://www.usenix.org/system/files/conference/usenixsecurity16/sec16_paper_biryukov .pdf) that may be valid for the last known functional block in a Shyft blockchain. As a Shyft blockchain recovers, the Shyft bridge would examine the existing Ethereum or other EVM/Shyft Safe compatible blockchains in order to determine the proper Safe status for the assets of the users that “transited” their assets to those blockchains when a Shyft network was unavailable.

In accordance with the embodiments of the present invention, a Shyft Network may be built to both enable the strongest security guarantees available (by having oracles on other completely independant blockchains able to see whether a Shyft blockchain may be functional), and to simultaneously have the ability to “fail gracefully” and enable users to maintain the liquidity of the majority of their assets while a Shyft blockchain may be unavailable.

In a another embodiment of the present invention, there may be a provided mechanisms of Shyft Bridge creation of meta-headers. In order to maintain cost control, there should be only one (1) header transmitted per Bridge checkpoint, to each connected blockchain. This single header should be constructed in order to provide a multi-layered merkle tree proof capability for any other blockchain headers, included in this Bridge checkpoint header.

Other blockchain headers (ethereum, ethereum classic, rootstock, etc.) that may be included are also multi-layered merkle tree proofs, composed of each other their blocks per their own checkpointing requirements (generally, these are the number of blocks on this blockchain that would be considered to have enough work proved on that network to be “safe” from block re-organizations). Ethereum for example has a checkpoint block which occurs once every (M=4) minutes. In a preferred embodiment, this may be referred to as a “span” for this blockchain. These “span” headers maybe then packaged in an index manner into a merkle tree, with the header of this being the header that may be transmitted to each connected blockchain. In a preferred embodiment, this may be referred to as a “Byfrost block”, which occurs once every (N=2) minutes or thereof.

In a preferred embodiment, this Byfrost block may be created from a merkle tree with various meta-data attached, and this header may be able to be used for the equivalent of an SPV proof for any of the included blockchain's “span” blocks.

To create the Byfrost block header, the mechanism may be the following:

For each Byfrost block (of time length N):

For each connected blockchain (of “span” packaging time length M):

On average, there will be (R=N/M) instances of the “span” blocks per blockchain, if this R value is <1, there is a probability that the “span” headers will be included in this “Byfrost block's constructed merkle tree.

Each blockchain's “span” header may be included (if applicable, and more than one if required) in an indexed merkle tree.

The Byfrost block header may be this merkle tree's header.

To create a proof for an SPV-like transaction, the mechanism may be the following:

Given a Byfrost block header to prove for

A piece of data (or) transaction receipt from a connected blockchain (T)

A given block number within the connected blockchain (M)

A given block number within the Byfrost block header architecture (N)

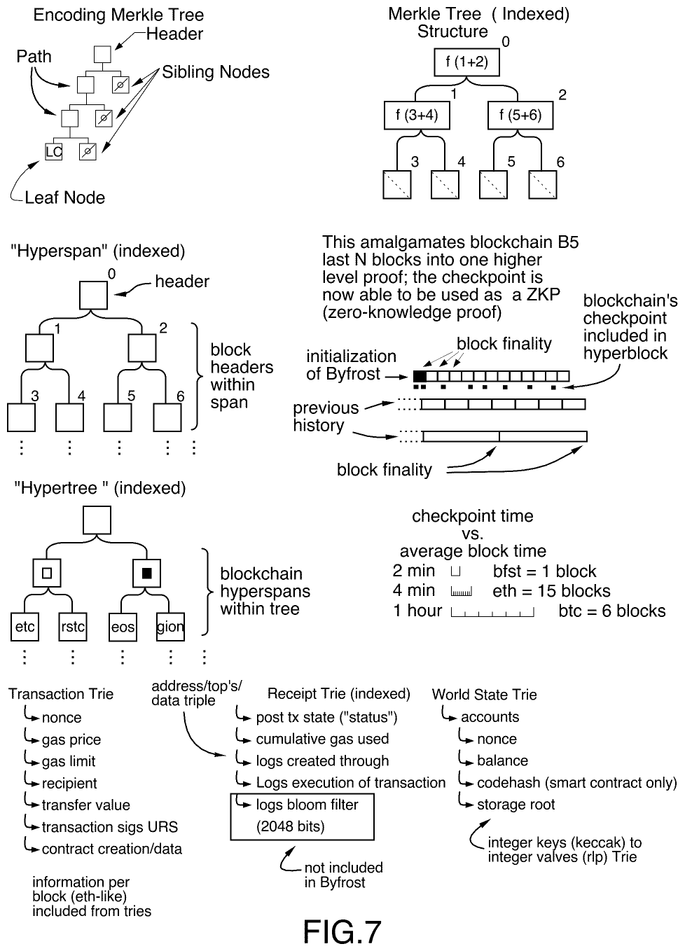

In a preferred embodiment, the data T may be hashed and it may be known to be included in block M of a given connected blockchain, for Ethereum-like blockchains this may be a Merkle Trie (compared to a Merkle Tree) database (see, for example, FIG. 7), but the proving mechanism may be the same. If it may be general data to be proven, a state-trie proof may be required, otherwise for general transactions (a Shyft Bridge's own asset-transmission transactions would occur as such) the receipt-trie proof may be used.

In a preferred embodiment, the proof of inclusion of T is run within block M of the connected blockchain. If B. passes, the proof of inclusion of block M is run within block N of the Byfrost block header architecture. If C. passes, the proof may be complete and the proof of total inclusion passes. In a preferred embodiment, it would then be known that the data or transaction receipt may be truly within the block architectures.

By these means, there is the ability, in a preferred embodiment of the present invention, to transmit, for extremely low cost, once every N time period, a single piece of data (the Byfrost block header) to each connected blockchain, that can prove any data or transactions across each connected blockchain's blocks for that time period.

In an embodiment of the present invention, this may be important because architecture like this can use headers from both private and public blockchains, as the efficiency may be the maximum possible. Only one new message needs to be added per connected blockchain (A1), as each existing connected blockchain's message of a Byfrost block header (B) will from then on also contain the connected blockchain's (A1) header within its merkle tree.

There may be provided in FIG. 7 a further embodiment of the present invention. FIG. 7 depicts the mechanism that a Shyft Bridge 404 uses to transmit checkpoint headers constructed from other blockchains, in a manner described herein.

Although this disclosure has described and illustrated certain preferred embodiments. As shown in FIG. 1, in a second situation, of the invention, it may be to be understood that the invention may be not restricted to those particular embodiments. Rather, the invention includes all embodiments which are functional or mechanical equivalence of the specific embodiments and features that have been described and illustrated.

The embodiments for which an exclusive privilege or property is claimed are as follows:

1. A method for identity verification of a first user by a second user implemented on a distributed ledger; the method comprising
a) the first user submits first user verification information to a verifier;
b) the verifier verifies the identity of the first user on the basis of the first user verification information and the verifier provides a public verification of the first user stored to the distributed ledger; and
c) the second user receives the public verification of the verifier stored on the distributed ledger upon transacting with the first user.

2. The method according to claim 1, wherein step (b) further comprises storing the first user verification information in a secure private environment.

3. The method of claim 2, wherein the first user verification information comprises digital copies of identifying documents of the first user, cryptographic hashes of those digital copies, and a metadata bitmap.

4. The method of claim 3, wherein the identity verification transaction is stored on the distributed ledger.

5. The method of claim 1, wherein the distributed ledger is a blockchain.

6. The method of claim 5, wherein the blockchain is compatible with the Ethereum Virtual Machine.

7. The method of claim 6, wherein the identity verification transactions are confirmed by a verification node.

8. The method of claim 7, wherein the verification nodes are in communication with a bridge node monitoring activity on the distributed ledger.

9. The method of claim 8, wherein the bridge node utilizes a smart contract to preserve the contents of the distributed ledger.

10. The method of claim 9, wherein the bridge node utilizes a smart contract to preserve the contents of the distributed ledger across a plurality of blockchains.

11. The method of claim 10, wherein step (c) further comprises the transmission of the first user's identity verification information over a communication channel to the second user.

12. The method of claim 11, wherein the transmission of identity verification information utilizes a de Bruijn sequence to find the requested identity verification information.

13. The method of claim 12, wherein the verifier is a financial institution.

14. The method of claim 13; wherein the financial institution is a bank.

15. The method of claim 13; wherein the financial institution is an exchange.

16. The method of claim 14; wherein the verifier monitors the identity verification transaction, provides notification and restricts the ability for the first or second user to engage in the identity verification transaction.
